(19) United States
(12) Patent Application Publication
(10) Pub. No.: US 2005/0022560 A1
(43) Pub. Date: Feb. 3, 2005

(54) Tank for melting solder glass

(75) Inventors: Mark S. Rowe, Oxford, NJ (US); Richard D. Lanam, Westfield, NJ (US); Krishnamurthy Vaithinathan, Bernardsville, NJ (US); Anatoliy N. Shchetkovskiy, Scotch Plains, NJ (US)

Correspondence Address: Engelhard Corporation, 101 Wood Avenue, P.O. Box 770, Iselin, NJ, 08830-0770, US

(73) Assignee: ENGELHARD CORPORATION

(21) Appl. No.: 10/877,579

(22) Filed: Jun. 25, 2004

Related U.S. Application Data
(60) Provisional application No. 60/484,996, filed on Jul. 3, 2003.

(51) Int. Cl. C03B 5/42

(52) U.S. Cl. 65/374.12; 65/374.11

(57) ABSTRACT

A melting tank for melting solder glass powders typically comprised of PbO and B₂O₃ and other minor ingredients. The tank contains surfaces exposed to the atmosphere and surfaces in contact with the molten solder glass. The surfaces of the tank that are in contact with the melt are comprised substantially entirely of iridium. Preferably, the surfaces exposed to the atmosphere contain a coating thereon of a metal or metal oxide such as palladium, ruthenium, rhodium, aluminum oxide, calcium oxide, cerium dioxide, dichromium oxide, hafnium dioxide, magnesium oxide, silicon dioxide, thorium dioxide, zirconia, mullite, magnesia spinel or zircon. It is also preferred that the cavity of the tank have a generally circular shape. The melting tank may be readily fabricated by wrought metallurgical processes or by electroforming.

### FIELD OF THE INVENTION

The invention pertains to a tank for producing a solder glass melt from a solder glass composite generally consisting of a mixture of powders wherein the principal ingredients are PbO and B₂O₃.

### BACKGROUND OF THE INVENTION

Generally, a composite solder glass comprises a powder mixture that contains a solder glass powder with a reduced melting temperature and a substantially inert filling material for adjustment of thermal expansion properties. Conventional solder glass powder contains PbO and B₂O₃ as the principal ingredients and, in particular cases, other minor ingredients such as SiO₂, ZnO, F, Bi₂O₃. It is well known that solder glasses are useful for sealing together pieces of materials such glass, ceramic and metals. In many instances, and regardless of whether vitreous or crystallized (i.e., devitrified) solder glass seals are employed, the components that they bond together are often used to encapsulate, or are otherwise connected with, delicate heat-sensitive parts such as electronic equipment, microelectronic circuitry, television tubes, solid state devices encapsulated in ceramic packages consisting of two layers of ceramic material bonded together by a solder glass.

Typically, the solder glass is fabricated by blending and melting the desired solder glass powder in a platinum tank at a temperature of about 1000° C. in an air atmosphere for about two hours. The resultant solder glass is then fritted over water-cooled rolls and ground to a particle size such that about 70% by weight of the particles are less than 400 mesh. Although such fabrication process is relatively straight forward and produces good results, the platinum tanks have a relatively short lifetime. Solder glass is typically regarded as a “universal solvent”, since it will dissolve any material that it comes in contact with while the solder glass is in a molten state.

Over the years, improvements have been made to extend the life of the platinum tanks used to fabricate the solder glass. Ceramic particles have been incorporated into the platinum matrix thereby increasing its lifetime. Also, increases in the useful life of the platinum tank have been obtained by insuring that all components of the solder glass powder are present in their oxidized form. It is well known that elemental (unoxidized) materials will combine with platinum at elevated temperatures, thereby shortening the life of the platinum melting tank.

U.S. Pat. No. 4,696,909 addresses the problem of reducing corrosion of the platinum melting tank by reducing the Pb₃O₄ content in the raw solder glass powder raw batch. However, this approach necessarily limits the number of different types of solder glasses that could be fabricated in the melting tank. It would be most advantageous if the tank life could be extended without imposing any constraints upon the types of solder glasses that could be fabricated in the melting tank.

### OBJECT OF THE INVENTION

It is an object of this invention to provide a solder glass composition melting tank that has a considerably longer lifetime than the platinum melting tanks currently in commercial use.

It is a further object of this invention to provide a design for the solder glass melting tank which will be more efficient than the design of the current platinum solder glass composition melting tanks.

It is yet a further object of the invention to provide a process for fabricating the solder glass melting tank of the invention.

### SUMMARY OF THE INVENTION

By way of summary, the invention relates to a melting tank for melting solder glass powder components having a cavity therein for containing such components in powdered and in molten form, said tank containing surfaces exposed to the atmosphere and components and surfaces in contact with the solder glass powder components and the molten solder glass, characterized in that the surfaces of the tank that are in contact with the components and the melt are comprised substantially entirely of iridium.

### BRIEF DESCRIPTION OF THE DRAWING

FIG. 1 is a perspective view of the preferred design of the iridium solder glass melting tank of the invention.

### DETAILED DESCRIPTION OF THE INVENTION

As mentioned above, the solder glass melting tank of the invention is characterized such that all of the surfaces and the components of the tank that will be in contact with the solder glass in its molten form are comprised substantially entirely of iridium (rather than platinum). Preferably the entire tank and all of its components are fabricated substantially entirely of iridium. For the purposes of this invention, the term “substantially entirely” shall mean that the iridium content shall be at least about 70 weight %. Thus, the tank and its components may be fabricated entirely from pure iridium or may be fabricated from an alloy of iridium in which the iridium content is at least about 70 wt. % and the alloying metal (that may be a metal such as rhodium, platinum, palladium, ruthenium, rhenium, etc.) will be present in a maximum amount of about 30 wt. %.

The cavity within the tank for containing the solder glass melt may be of any desired shape, e.g., square, rectangular, oblong, oval etc., but is preferably generally circular. It has been found that a circular cavity heats more evenly and has a higher efficiency in melting the solder glass powder components.

Since iridium has a tendency to form volatile oxidation products under the temperature conditions required for melting the solder glass powder components, it is preferred that the external surfaces of the melting tank which are exposed to the atmosphere, i.e., not in contact with the solder glass powder components or the molten solder glass, be coated with a metal or metal oxide that will deter such volatilization. Suitable metals and metal oxides for such external coating include platinum, palladium, ruthenium, rhodium, aluminum oxide, calcium oxide, cerium dioxide, dichromium oxide, hafnium dioxide, magnesium oxide, silicon dioxide, thorium dioxide, zirconia, mullite, magnesia spinel, zircon or mixtures of two or more of the foregoing metals and/or metal oxides. The coating may be readily applied to the external surfaces of the melting tank by well-known techniques such as plasma-jet spraying.

### DETAILED DESCRIPTION OF THE DRAWING

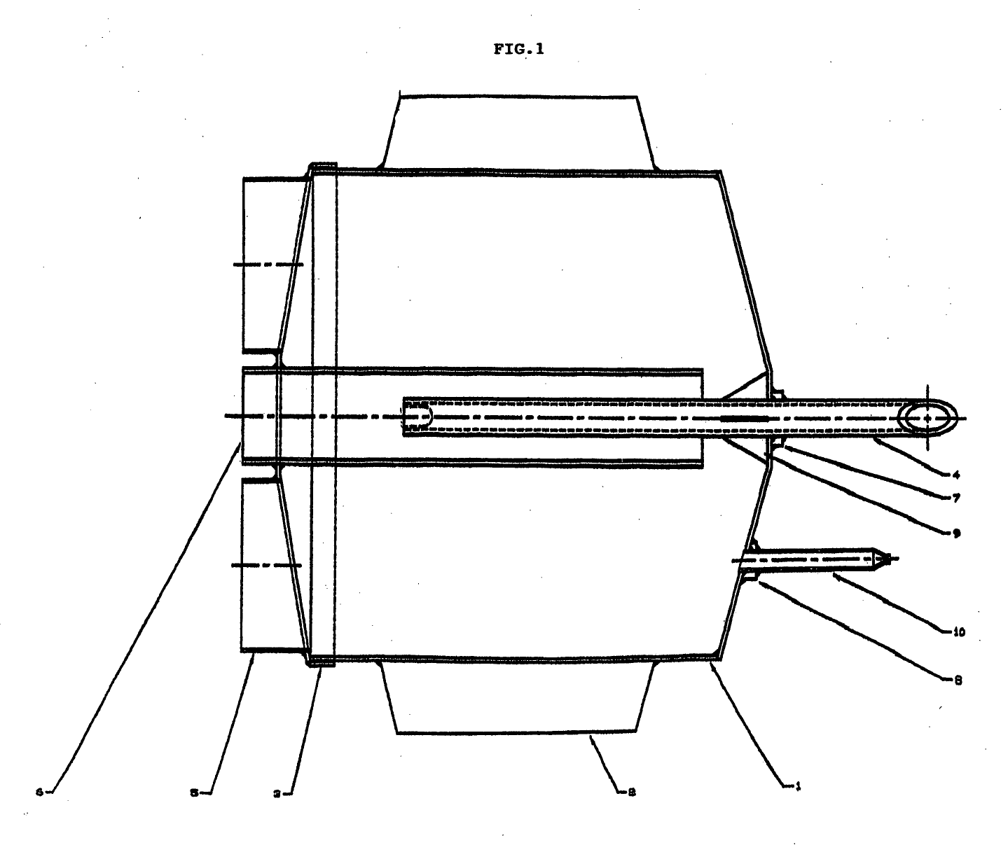

FIG.1 is a perspective view of the solder melting tank of the invention in which reference numeral 1 refers to the welded body of the tank. Body 1 electrical lugs 2 adapted to be connected to an external electrical power source. When electrical power is supplied to lugs 2, the entire tank acts as a resistance heater to supply the necessary heat for melting the solder glass powder components. Body 1 is equipped with a top cover plate 3 for minimizing exposure of the solder glass batch to the atmosphere during the melting operation. The solder glass powders are fed into body 1 through glass fill ports 5 and after the melting operation has been completed, the solder glass product is removed from the body 1 through glass drain tube 4. Drain tube 4 is supported within the tank by means of support rings 7 and 9. Body 1 is fitted with overflow port 6 in order to allow removal of any excess solder glass, which might otherwise overflow the tank. The tank also contains a bleed-off tube 10 (to allow venting to the atmosphere as may be necessary); tube 10 is supported within body 1 by means of support ring 8.

The melting tank of the invention, including its internal components, is preferably fabricated entirely of iridium metal. The iridium components may be readily fabricated either by well-known wrought metallurgical processes or by electroforming. Typically, wrought metallurgical process would be used for producing the body of the melting tank and the electroforming process would be used for fabricating the asymmetric components, e.g., the tubes.

Wrought metallurgical processes include melting of the iridium ingot, working the ingot with rolling and annealing to produce sheets of the desired dimensions and thickness. Segments of the desired shapes may then be cut from such sheets and/or the sheets may be formed into the desired shapes. The components may thereafter be assembled and welded to the body of the melting tank by using welding processes such as gas tungsten arc welding. The resultant assembled and welded melting tank is thereafter inspected for soundness using test methods such as dye penetrant inspection.

Various methods are available for the deposition of iridium onto a mandrel of the required shape. Such methods include metallorganic chemical vapor deposition, thermal deposition and electrodeposition. Dense, non-porous layers of iridium and its alloys having the required thickness can be deposited from molten salt electrolytes as described in more detail below.

The molten salt electrolytes process typically utilizes a mixture of alkaline metal halides containing a compound of iridium. The electrodeposition process for iridium and its alloys may be accomplished in an electrolyzer with an inert atmosphere at temperatures of about 600 to about 700° C. The mandrel upon which the electrodeposition takes place is usually fabricated of graphite which is easily machined and polished and provides a tolerance of ±10-20μ. The inner surface of the electroformed product will be a replica of the mandrel surface. After the layer with the desired thickness is deposited on the mandrel, the mandrel is extracted from the electrolyzer and the mandrel is removed.

During the electrolysis process, the metal is purified. Therefore, iridium scrap can be used as the starting material. The electroformed iridium will typically have a density of about 22.55 to about 22.56 g/cm³. Despite the columnar structure of the electroformed iridium, it has a high degree of ductility and, after heat-treatment, it can be deformed at room temperature.

Electroformed iridium has a rupture strength of 16.3 N/mm² at 1800° C., a value that is essentially equivalent to the rupture strength of 17 N/mm² for melted and rolled material. The electroforming technology allows for a reduction in the production cycle from 6-8 weeks to 2-3 weeks. The efficient use of iridium metal when compared, as a ratio of the weight of the final product to the weight of metal used in the manufacturing process, is twice as high for the electroforming method as compared wrought metallurgical processes. Furthermore, the manufacturing losses associated with the electroforming process are significantly lower than the manufacturing losses associated with wrought metallurgical processes. In addition, the electroforming process permit the fabrication of objects with complex shapes that are frequently difficult or impracticable to obtain by conventional metallurgical processes. It has been found that the required tubes for the melting tank of the invention fabricated by the electroforming method are seamless, have excellent uniformity and are very suitable for use in high temperature applications.

1. A melting tank for melting solder glass powder components having a cavity therein for containing such components in powdered and in molten form, said tank containing surfaces exposed to the atmosphere and components and surfaces in contact with the solder glass powder components and the molten solder glass, characterized in that the surfaces of the tank that are in contact with the components and the melt are comprised substantially entirely of iridium.

2. The tank of claim 1 wherein the surfaces of the tank exposed to the atmosphere contain a coating thereon of a metal or metal oxide that will deter volatilization of oxides of iridium from such tank surfaces during the melting of the solder glass powder components.

3. The tank of claim 1 wherein the metal or metal oxide is selected from the group consisting of platinum, palladium, ruthenium, rhodium, aluminum oxide, calcium oxide, cerium dioxide, dichromium oxide, hafnium dioxide, magnesium oxide, silicon dioxide, thorium dioxide, zirconia, mullite, magnesia spinel and zircon.

4. The tank of claim 1 further comprising:
(a) a welded body;
(b) electrical lugs for connection to an external electrical power source;
(c) a plate for covering the top of the tank;
(d) at least one solder glass melt drain tube;
(e) at least one solder glass composition fill port;
(f) at least one solder glass melt overflow port;
(g) at least one support ring for supporting the drain tube;
(h) at least one bleed-off tube; and
(i) at least one support ring for supporting the bleed-off tube.

5. The tank of claim 1 wherein the cavity has a generally circular shape.

6. The tank of claim 1 that is fabricated substantially entirely of iridium.

7. The tank of claim 1 that is fabricated by a wrought metallurgical process.

8. The tank of claim 1 that is fabricated by an electroforming process.

9. The tank of claim 1 wherein the surfaces of the tank that are in contact with the components and the melt are comprised of an iridium alloy wherein the iridium content is at least about 70 wt. %.

10. The tank of claim 9 wherein the iridium is alloyed with a metal selected from the group consisting of rhodium, platinum, palladium, ruthenium and rhenium.
